(19) United States
(12) Patent Application Publication
(10) Pub. No.: US 2016/0230071 A9
(43) Pub. Date: Aug. 11, 2016

(54) Methods for Plug Cementing

(71) Applicant: SCHLUMBERGER TECHNOLOGY CORPORATION, Sugar Land, TX (US)

(72) Inventors: Lijun Lin, Sugar Land, TX (US); Philip F. Sullivan, Bellaire, TX (US); Dominique Guillot, Fontenay Aux Roses (FR); Bruno Drochon, Houston, TX (US)

(73) Assignee: SCHLUMBERGER TECHNOLOGY CORPORATION, Sugar Land, TX (US)

(21) Appl. No.: 13/623,109

(22) Filed: Sep. 20, 2012

Related U.S. Application Data
(63) Continuation-in-part of application No. 13/301,240, filed on Nov. 21, 2011.

(51) Int. Cl. E21B 33/16; C04B 28/04; C04B 26/04; E21B 33/13; C09K 8/46

(52) U.S. Cl. CPC C09K 8/426; E21B 33/13; C09K 8/46; C04B 26/04; C04B 28/04

(57) ABSTRACT

Compositions comprise polyacrylamide, a non-metallic crosslinker and a pH-adjustment material. Such compositions have utility in the context of remedial cementing, plug cementing in particular. The compositions may be pumped into a subterranean well, where they polymerize and form a support on which a cement plug may sit. The support may maintain the position of the cement plug in the wellbore and minimize cement-plug contamination.

### BACKGROUND

The statements in this section merely provide background information related to the present disclosure and may not constitute prior art.

This disclosure relates to methods for servicing subterranean wells, in particular, fluid compositions and methods for remedial cementing operations.

Remedial cementing is a general term to describe operations that employ cementitious fluids to cure a variety of well problems. Such problems may occur at any time during the life of the well, from well construction to well stimulation, production and abandonment. Remedial cementing is commonly divided into two broad categories—plug cementing and squeeze cementing. Plug cementing consists of placing cement slurry in a wellbore and allowing it to set. Squeeze cementing consists of forcing cement slurry through holes, splits or fissures in the casing/wellbore annular space.

During construction of a subterranean well, remedial operations may be required to maintain wellbore integrity during drilling, to cure drilling problems, or to repair defective primary cement jobs. Wellbore integrity may be compromised when drilling through mechanically weak formations, leading to hole enlargement. Cement slurries may be used to seal and consolidate the borehole walls. Remedial cementing is a common way to repair defective primary cement jobs, to either allow further drilling to proceed or to provide adequate zonal isolation for efficient well production.

During well production, remedial cementing operations may be performed to restore production, change production characteristics (e.g., to alter the gas/oil ratio or control water production), or repair corroded tubulars. During a stimulation treatment, the treatment fluids must enter the target zones and not leak behind the casing. If poor zonal isolation behind the production casing is suspected, a remedial cementing treatment may be necessary.

Well abandonment frequently involves placing cement plugs to ensure long-term zonal isolation between geological formations, replicating the previous natural barriers between zones. However, before a well can be abandoned, annular leaks must be sealed. Squeeze cementing techniques may be applied for this purpose.

Cementitious fluid systems employed during remedial-cementing operations may comprise Portland cement slurries, lime/silica blends, lime/pozzolan blends, calcium-aluminate cement slurries, Sorel cements, zeolites, chemically bonded phosphate ceramics, geopolymers and organic resins based on epoxies or furans.

The most common method for placing a cement plug is the balanced-plug technique (FIG. 1). Tubing or drillpipe 101 is run into the wellbore 102 to the desired depth of the plug base 103. To avoid contamination by other wellbore fluids, appropriate volumes of spacer fluid 104 or chemical wash may be pumped ahead of and behind the cement slurry 105. A displacement fluid or drilling fluid 106 may reside above the spacer fluid. The volumes are such that they correspond to the same heights in the annulus and in the pipe, thus achieving a hydrostatic balance. Once the plug is balanced, the pipe is slowly pulled out of the cement to a depth above the plug, and excess cement slurry is reversed out.

A problem that may arise during placement of a balanced plug is contamination by fluids that reside below the plug. To minimize downward migration of the cement plug, fluids with high gel strengths may be placed as a base 107. Examples of such fluids include thixotropic bentonite suspensions, silicate gels or crosslinked polymer pills. The pills may be weighted to a density higher than that of the cement plug to ensure better stability of the interface. Mechanical devices such as inflatable packers, diaphragms and umbrella-shaped membranes may also be used as bases for cement plugs.

A thorough overview of remedial cementing compositions and practices may be found in the following publication. Daccord G et al.: “Remedial Cementing,” in Nelson E B and Guillot D (eds.): Well Cementing, 2^{nd} Edition, Houston: Schlumberger (2006) 503-547.

### SUMMARY

In an aspect, embodiments relate to methods for setting a cement plug in a subterranean wellbore. A process fluid composition is prepared that comprises at least 1 wt % polyacrylamide and a non-metallic crosslinker. The composition is placed in the wellbore and allowed to crosslink and form a gel. A cement slurry is prepared and placed in the wellbore such that is rests on top of the gel, thereby forming the plug.

In a further aspect, embodiments relate to methods for treating a subterranean wellbore. A process fluid composition is prepared that comprises at least 1 wt % polyacrylamide and a non-metallic crosslinker. The composition is placed in the wellbore and allowed to crosslink and form a gel. A cement slurry is prepared and placed in the wellbore such that is rests on top of the gel, thereby forming the plug. The molecular weight of the polyacrylamide may be between about 10,000 g/mol and 20 million g/mol.

### BRIEF DESCRIPTION OF THE DRAWINGS

FIG. 1 presents an illustration of a balanced cement plug.

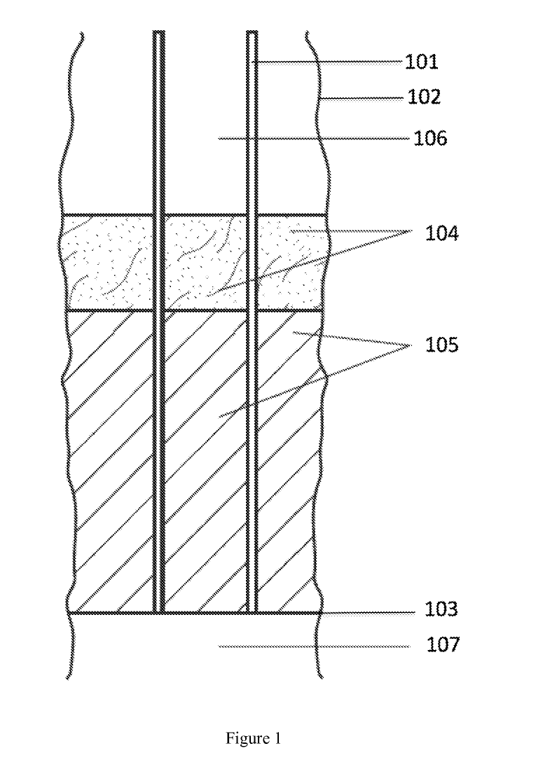

FIG. 2 presents the complex viscosities of aqueous polyacrylamide (PAM)—polyvinylpyrrolidone (PVP) gels containing various amounts of oil-base drilling fluid (OBM).

FIG. 3 presents the complex viscosities of aqueous polyacrylamide-polyvinylpyrrolidone gels containing various amounts of water-base drilling fluid (WBM).

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and the detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood the Applicant appreciates and understands that any and all data points within the range are to be considered to have been specified, and that the Applicant possessed knowledge of the entire range and all points within the range.

The following definitions are provided in order to aid those skilled in the art to understand the detailed description.

The term “treatment,” or “treating,” refers to any subterranean operation that uses a fluid in conjunction with a desired function and/or for a desired purpose. The term “treatment,” or “treating,” does not imply any particular action by the fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

As used herein, the term “process fluid” refers to a pumpable fluid that may be circulated in a subterranean well. Such fluids may include drilling fluids, cement slurries, spacer fluids, pills, chemical washes, completion fluids, fracturing fluids, gravel-pack fluids and acidizing fluids. Those skilled in the art will recognize that pumpable fluids may have viscosities lower than about 1000 cP at a shear rate of 100 s⁻¹.

As used herein, the term “gel” refers to a solid or semi-solid, jelly-like composition that can have properties ranging from soft and weak to hard and tough. The term “gel” refers to a substantially dilute crosslinked system, which exhibits no flow when in the steady-state, which by weight is mostly liquid, yet behaves like a solid due to a three-dimensional crosslinked network within the liquid. It is the crosslinks within the fluid that give a gel its structure (hardness) and contribute to stickiness. Accordingly, gels are a dispersion of molecules of a liquid within a solid in which the solid is the continuous phase and the liquid is the discontinuous phase. A gel is considered to be present when the Elastic Modulus G′ is larger than the Viscous Modulus G,” when measured using an oscillatory shear rheometer (such as a Bohlin CVO 50) at a frequency of 1 Hz and at 20° C. The measurement of these moduli is well known to one of minimal skill in the art, and is described in An Introduction to Rheology, by H. A. Barnes, J. F. Hutton, and K. Walters, Elsevier, Amsterdam (1997).

The term polyacrylamide refers to pure polyacrylamide homopolymer or copolymer with near zero amount of acrylate groups, a polyacrylamide polymer or copolymer with a mixture of acrylate groups and acrylamide groups formed by hydrolysis and copolymers comprising acrylamide, acrylic acid, and/or other monomers.

This disclosure incorporates process fluids that may comprise polyacylamide crosslinked with a non-metallic crosslinker. The non-metallic crosslinkers do not include metals, but are instead organic molecules, oligomers, polymers, and/or the like. The polyacrylamide may have a weight average molecular weight higher than or equal to about 10,000 g/mol and lower than or equal to about 20 million g/mol, or between about 500,000 g/mol and about 5 million g/mol. The polyacrylamide may have a degree of hydrolysis of from 0% up to less than or equal to about 40%, or from 0.05% up to less than or equal to about 20%, or from 0.1% up to less than or equal to about 15%.

The non-metallic crosslinker may comprise a polylactam. Polylactams include any oligomer or polymer having pendent lactam (cyclic amide) functionality. Polylactams may be homopolymers, copolymers, block-copolymers, grafted polymers, or any combination thereof comprising from 3 to 20 carbon atoms in the lactam functional group pendent to the polymer backbone. Examples include polyalkyl-beta lactams, polyalkyl-gamma lactams, polyalkyl-delta lactams, polyalkyl-epsilon lactams, polyalkylene-beta lactams, polyalkylene-gamma lactams, polyalkylene-delta lactams, polyalkylene-epsilon lactams, and the like. Other examples of polylactams include polyalkylenepyrrolidones, polyalkylenecaprolactams, polymers comprising Vince lactam (2-azabicyclo[2.2.1]hept-5-en-3-one), decyl lactam, undecyl lactam, lauryl lactam, and the like. The alkyl or alkylene substituents in these polymers may include any polymerizable substituent having from 2 to about 20 carbon atoms, e.g., vinyl, allyl, piperylenyl, cyclopentadienyl, or the like. The non-metallic crosslinker may be polyvinylpyrrolidone, polyvinylcaprolactam, or a combination thereof. In the present disclosure, polyvinylpyrrolidone may have a weight average molecular weight higher than or equal to about 10,000 g/mol and less than or equal to about 2 million g/mol, or higher than or equal to 50,000 g/mol and less than or equal to about 2 million g/mol.

Once crosslinking occurs, the process fluid may become a gel.

The process fluid may have an initial pH between about 3 and about 9. Accordingly, the process fluid may further comprise a pH-adjusting agent that causes the fluid pH to fall below 3 or rise above 9. Such agents may comprise a base, an acid, a pH buffer, or any combination thereof. Such agents may comprise an alkali metal hydroxide, magnesium oxide, sodium carbonate, sulfuric acid, an organic acid, carbon dioxide or a combination thereof.

The Applicant has determined that the disclosed polyacrylamide process fluids have utility in the context of plug cementing. The process fluids may form gels with sufficient strength to support a cement plug and prevent contamination of the plug by other wellbore fluids.

An aqueous process fluid may be prepared that comprises at least 1 wt % polyacrylamide and a non-metallic crosslinker. The fluid may then be pumped downhole, whereupon the polyacrylamide crosslinks and forms a support for a cement plug. To facilitate gel development, the process fluid may further comprise a pH adjustment material in an amount such that the pH of the polyacrylamide-crossliker formulation is higher than or equal to 11 or lower than or equal to 1. Suitable pH adjustment materials may comprise alkali metal hydroxides, magnesium oxide, sodium carbonate, sulfuric acid, an organic acid, carbon dioxide and other such materials well known in the art. The process fluid may be water-base, oil-base, a water-in-oil emulsion or an oil-in-water emulsion.

The rate at which the crosslinking reaction proceeds may be controlled. For example, the polyacrylamide and non-metallic crosslinker may be placed downhole in separate streams. The streams may commingle in the wellbore and crosslinking commences, forming the support. Another technique may be to prepare the crosslinked polyacrylamide gel in advance and freeze dry the gel. The freeze-dried gel may then be incorporated into the process fluid and placed into the well. At this point, formation water may hydrate the freeze-dried gel particles, thereby forming the support. One may control the rate at which the freeze-dried gel dissolves and hydrates by varying the particle size of the gel particles. In yet another technique, the freeze-dried particles may be added to an oil-base drilling fluid. When pumped into the well, the particles may encounter formation water and may commence hydrating and forming a support. In yet another technique, solid polyacrylamide, non-metallic crosslinker and pH adjustment material may be added to an oil-base process fluid. When the suspended polyacrylamide, non-metallic crosslinker and pH adjustment material encounter formation water, hydration and crosslinking may commence and thereby form a support.

Yet another technique for controlling gel formation may be to partition the polyacrylamide, non-metallic crosslinker and pH adjustment material in different phases of an emulsion process fluid. The process fluid may be an oil-in-water emulsion or a water-in-oil emulsion. For example, the pH adjustment material may dissolved in the aqueous phase and the other ingredients dispersed in the oil phase. Those skilled in the art will appreciate that any arrangement of the ingredients may be effective, as long as one of them is in a phase that is different than the other two. The Applicant envisions several techniques by which the emulsions may be destabilized, thereby triggering the crosslinking reaction. One technique may be to design the emulsion such that it becomes unstable upon contact with formation water in the well. Another technique may be to design the emulsion such that it becomes unstable upon exposure to shear—for example the shear provided by pumping the emulsion through a drill bit. Destabilization of the emulsion may cause the ingredients to commingle, thereby initiating the crosslinking reaction. Yet another technique may be to encapsulate one or more of the ingredients, and incorporate the capsules in the process fluid. The capsule coating may be degraded inside the wellbore by, for example, exposure to heat, pressure, formation water or other changes in chemical environment known in the art. The coating may also be degraded by, for example, exposure to shear, ultrasonic vibration, x-ray or gamma-ray irradiation, microwave irradiation or other electromechanical stimuli known in the art.

For all of the techniques described above, the efficiency of plug-support formation may be enhanced by including solid additives in the process fluid. The solids may comprise granular, lamellar and fibrous substances. Granular materials may comprise nutshells, plastic beads, limestone particles, sulfur particles, expanded perlite or cottonseed hulls and combinations thereof. The particle size of the granular materials may be between about 10 μm and 10,000 μm, or may be between about 100 μm and 1000 μm The concentration of the granular materials may vary between about 2.85 kg/m³ and 428 kg/m³ (1 lbm/bbl and 150 lbm/bbl), or may vary between about 28.5 kg/m³ and 342 kg/m³ (10 lbm/bbl and 120 lbm/bbl). Lamellar materials may comprise cellophane flakes, polyester flakes or mica or combinations thereof. The flake size may vary between about 6 mm×6 mm and about 25 mm×25 mm, or may vary between about 13 mm×13 mm and about 19 mm×19 mm. The concentration of the lamellar materials may vary from about 2.85 kg/m³ and 28.5 kg/m³ (1 lbm/bbl and 10 lbm/bbl), or may vary between about 14.3 kg/m³ and 22.8 kg/m³ (5 lbm/bbl and 8 lbm/bbl). The flakes need not necessarily have a square profile. Fibrous materials may comprise sawdust, prairie hay, tree bark, shredded wood, glass fibers, carbon fibers, nylon fibers, polyvinylalcohol fibers, polylactic acid fibers, polyvinylchloride fibers, polyethylene fibers, or polyurethane fibers or combinations thereof. The fiber length may vary between about 1 mm and about 15 mm, or between about 5 mm and 10 mm. The fiber concentration may vary between about 28.5 kg/m³ and about 171 kg/m³ (10 lbm/bbl and 60 lbm/bbl), or may vary from about 57 kg/m³ and about 128 kg/m³ (20 lbm/bbl and 45 lbm/bbl). The fibers may be linear or curved.

For all of the techniques discussed above, the viscosities of the process fluids before crosslinking may be within the pumpable range; i.e., lower than 1000 cP at a shear rate of 1000 s⁻¹.

Those skilled in the art will recognize that the formation of cement-plug supports envisioned by the Applicant is not necessarily limited to the techniques described above.

In an aspect, embodiments relate to methods for setting a cement plug in a subterranean wellbore. A process fluid composition is prepared that comprises at least 1 wt % polyacrylamide and a non-metallic crosslinker. The composition is placed in the wellbore and allowed to crosslink and form a gel. A cement slurry is prepared and placed in the wellbore such that is rests on top of the gel, thereby forming the plug.

In a further aspect, embodiments relate to methods for treating a subterranean wellbore. A process fluid composition is prepared that comprises at least 1 wt % polyacrylamide and a non-metallic crosslinker. The composition is placed in the wellbore and allowed to crosslink and form a gel. A cement slurry is prepared and placed in the wellbore such that is rests on top of the gel, thereby forming the plug. The molecular weight of the polyacrylamide may be between about 10,000 g/mol and 20 million g/mol.

Those skilled in the art will also recognize that the process fluid may further comprise one or more viscosifiers. Some non-limiting examples of viscosifiers include (but are not limited to) hydratable gels (e.g. guars, poly-saccharides, xanthan, hydroxy-ethyl-cellulose, etc.), a crosslinked hydratable gel, a viscosified acid (e.g. gel-based), an emulsified acid (e.g. oil outer phase), an energized fluid (e.g. an N₂ or CO₂ based foam) and viscoelastic surfactants (VES). Additionally, the carrier fluid may be a brine, and/or may include a brine.

The VES may be selected from the group consisting of cationic, anionic, zwitterionic, amphoteric, nonionic and combinations thereof. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

A zwitterionic surfactant of the family of betaines may be used. Exemplary cationic viscoelastic surfactants include amine salts and quaternary ammonium salts. Exemplary amphoteric viscoelastic surfactant systems include for example amine oxides and amidoamine oxides. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide. Suitable anionic surfactants include alkyl sarcosinates.

The process fluid may optionally further comprise additional additives, including weighting agents, fluid loss control additives, gas migration control additives, colloidal-size minerals, corrosion inhibitors, scale inhibitors, catalysts, clay control agents, biocides, friction reducers and combinations thereof and the like. Suitable weighting agents may include silica, barite, hematite, ilmenite or manganese tetraoxide or combinations thereof.

The process fluid may further comprise sodium chloride, potassium chloride, calcium chloride, calcium bromide, zinc bromide, sodium formate, potassium formate or cesium formate or combinations thereof.

The placement method may incorporate a variety of techniques known to those skilled in the art. For example, coiled tubing, casing or drillpipe may be used to convey the process fluid into the well. Or, the process fluid may be conveyed to the lost circulation zone by a dump bailer.

The placement method may also incorporate the use of pre- and post-flushes. For example, a high-pH (e.g., >9) or neutral-pH fluid may be pumped ahead of or behind the disclosed process fluids, or both. Such a technique may help prevent the process fluid from flowing into permeable formations, and confine the process fluid to wellbore region.

### EXAMPLES

The following examples serve to better illustrate the present disclosure. All examples employ process fluids comprising the following ingredients: (1) partially hydrolyzed (10%) polyacrylamide with a molecular weight of about 5 million, MAGNAFLOC 24 available from Ciba Specialty Chemicals; (2) polyvinylpyrrolidone with a molecular weight of 55,000, available from Aldrich Chemicals; and sodium hydroxide. The following aqueous fluid formulation was used in all of the examples: 3 wt % polyacrylamide, 6 wt % polyvinylpyrrolidone and sufficient NaOH to achieve a fluid pH between 11 and 12. The polyacrylamide and polyvinylpyrrolidone were prehydrated in water before adjusting the pH.

### Example 1

The aforementioned polyacrylamide/polyvinylpyrrolidone (PAM/PVP) composition at pH 12 was prepared and placed in a series of glass jars. Various volumes of cement slurry were then poured on top of the gels, thereby varying the hydrostatic pressure or stress on the gels. The slurry was neat Class G cement+44% water by weight of cement. Visual observations of the effects are summarized in Table 1.

TABLE 1
Ability of PAM/PVP Composition to Support Cement Slurry Column.

| Cement Slurry | Jar Diameter | Induced Stress | |
|---|---|---|---|
| (g) | (mm) | (kPa) | Remarks |
| 40 | 44 | 0.26 | Gel sufficiently strong. |
| 80 | 44 | 0.52 | Gel sufficiently strong. |
| 120 | 44 | 0.77 | Gel sufficiently strong. |
| 160 | 44 | 1.03 | Gel sufficiently strong. |
| 300 | 56 | 1.19 | Gel sufficiently strong. |
| 60 | 23.5 | 1.36 | Gel sufficiently strong. |
| 20 | 26 | 4.06 | Gel sufficiently strong. |

In all cases, the gel was able to support the cement column No commingling was observed. The cement slurry also set in all cases, indicating the presence of the gel did not disrupt the cement-setting process.

### Example 2

This example was similar to Example 1, except that the fluids were placed in 2.54-cm (1-in) diameter clear plastic tubing instead of jars. In addition, the effects of a water-base and an oil-base drilling fluid were investigated. The water-base drilling fluid, prepared by MI-Swaco, comprised water, barite, polymers and REV DUST (available from MI-Swaco). The fluid density was 1170 kg/m³. The oil-base mud, prepared by MI-Swaco, was a water-in-oil emulsion comprising water, oil, barite, calcium chloride and polymers. The fluid density was 1900 kg/m³. The previously described PAM/PVP gels were prepared at pH 12 and transferred to the tubing. Cement slurry was placed above them. When present, the drilling fluid was placed below the gel. Three tests were performed:

1. 50 g gel; 500 g cement slurry

2. 50 g gel; 400 g cement slurry; 50 g water-base drilling fluid

3. 50 g gel; 400 g cement slurry; 50 g oil-base drilling fluid

In all three cases, the gel supported the cement slurry. In cases when drilling fluid was present, the gel did not commingle with the drilling fluid. After aging overnight, the cement slurry set normally.

### Example 3

Experiments were performed to investigate the compatibility of the PAM/PVP gel with a water-base drilling fluid and an oil-base drilling fluid. The gel was mixed with the drilling fluids in the following ratios: 10 wt % drilling fluid; 30 wt % drilling fluid; 50 wt % drilling fluid; 100 wt % drilling fluid; and 200 wt % drilling fluid. Complex viscosities were measured by placing the mixtures in a Bohlin rheometer.

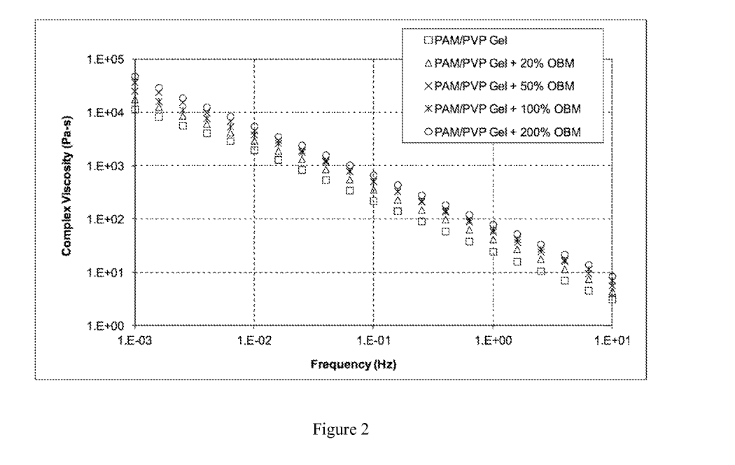

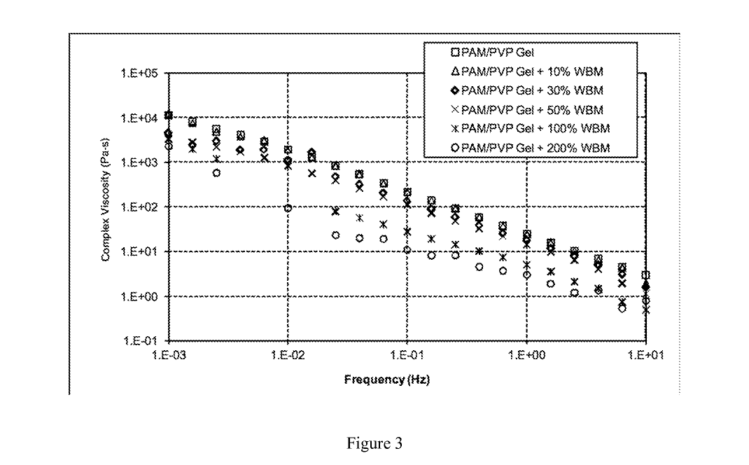

As shown in FIGS. 2 and 3, the complex viscosity steadily decreased with the drilling fluid concentration. No precipitous loss of viscosity was observed.

In addition to the rheology measurements, tubing experiments similar to those described in Example 2 were performed. This time the PAM/PVP gel was pre-mixed with either 20 wt % water-base drilling fluid or 20% oil-base drilling fluid. In both cases, the gel was still able to support the cement-slurry column.

### Example 4

Experiments were performed that are similar to those described in

Example 2. However, this time the PAM/PVP gel was prepared in a saturated potassium formate brine instead of fresh water. The brine density was 2180 kg/m³ (18.2 lbm/gal). In addition, the PAM and PVP were not prehydrated in the brine; instead, they were added as solids to form a suspension.

Three tests were performed:

1. 110 g gel; 400 g cement slurry

2. 110 g gel; 400 g cement slurry; 50 g water-base drilling fluid

3. 110 g gel; 400 g cement slurry; 50 g oil-base drilling fluid

In all three cases, the gel supported the cement slurry. In cases when drilling fluid was present, the gel did not commingle with the drilling fluid. After aging overnight, the cement slurry set normally.

Additional tests were performed with gels that were contaminated with 20 wt % of water-base or oil-base drilling fluid. In both cases, the gel was still able to support the cement-slurry column

Although various embodiments have been described with respect to enabling disclosures, it is to be understood that the preceding information is not limited to the disclosed embodiments. Variations and modifications that would occur to one of skill in the art upon reading the specification are also within the scope of the disclosure, which is defined in the appended claims.

1. A method for setting a cement plug in a subterranean wellbore, comprising:
i. preparing an aqueous process fluid composition comprising more than 1 wt % polyacrylamide and a non-metallic crosslinker;
ii. placing the composition into the wellbore;
iii. allowing the composition to crosslink and form a gel;
iv. preparing a cement slurry; and
v. placing the slurry in the wellbore.

2. The method of claim 1, wherein the non-metallic crosslinker comprises a polylactam.

3. The method of claim 1, wherein the non-metallic crosslinker comprises polyvinylpyrrolidone, polyvinylcaprolactam or a combination thereof.

4. The method of claim 3, wherein the polyvinylpyrrolidone has a weight average molecular weight of greater than or equal to about 50,000 g/mol and less than or equal to about 2 million g/mol.

5. The method of claim 1, wherein the non-metallic crosslinker has a weight average molecular weight greater than or equal to about 10,000 g/mol and less than or equal to about 2 million g/mol.

6. The method of claim 1, wherein the polyacrylamide has a degree of hydrolysis higher than or equal to about 0% and lower than or equal to about 40%.

7. The method of claim 1, wherein the molecular weight of the polyacrylamide is between about 10,000 g/mol and 20 million g/mol.

8. The method of claim 1, wherein the pH of the composition is adjusted such that the pH is higher than or equal to 11 or lower than or equal to 1.

9. The method of claim 1, wherein the composition further comprises sodium chloride, potassium chloride, calcium chloride, calcium bromide, zinc bromide, sodium formate, potassium formate, cesium formate or combinations thereof.

10. The method of claim 1, wherein the cement slurry comprises Portland cement, a lime/silica blend, a lime/pozzolan blend, calcium aluminate cement, zeolites, a chemically bonded phosphate ceramic, geopolymers or combinations thereof.

11. The method of claim 1, wherein the composition further comprises silica, barite, hematite, ilmenite, manganese tetraoxide, glass fibers, carbon fibers, nylon fibers, polyvinylalcohol fibers, polylactic acid fibers, polyvinylchloride fibers, polyethylene fibers or polyurethane fibers or combinations thereof.

12. A method for treating a subterranean wellbore, comprising:
i. preparing an aqueous process fluid composition comprising more than 1 wt % polyacrylamide and a non-metallic crosslinker;
ii. placing the composition into the wellbore;
iii. allowing the composition to crosslink and form a gel;
iv. preparing a cement slurry; and
v. placing the slurry in the wellbore;
wherein, the molecular weight of the polyacrylamide is between about 10,000 g/mol and 20 million g/mol.

13. The method of claim 12, wherein the non-metallic crosslinker comprises a polylactam.

14. The method of claim 12, wherein the non-metallic crosslinker comprises polyvinylpyrrolidone, polyvinylcaprolactam or a combination thereof.

15. The method of claim 14, wherein the polyvinylpyrrolidone has a weight average molecular weight of greater than or equal to about 50,000 g/mol and less than or equal to about 2 million g/mol.

16. The method of claim 12, wherein the non-metallic crosslinker has a weight average molecular weight greater than or equal to about 10,000 g/mol and less than or equal to about 2 million g/mol.

17. The method of claim 12, wherein the polyacrylamide has a degree of hydrolysis higher than or equal to about 0% and lower than or equal to about 40%.

18. The method of claim 1, wherein the pH of the composition is adjusted such that the pH is higher than or equal to 11 or lower than or equal to 1.

19. The method of claim 1, wherein the composition further comprises sodium chloride, potassium chloride, calcium chloride, calcium bromide, zinc bromide, sodium formate, potassium formate, cesium formate or combinations thereof.

20. The method of claim 1, wherein the composition further comprises silica, barite, hematite, ilmenite, manganese tetraoxide, glass fibers, carbon fibers, nylon fibers, polyvinylalcohol fibers, polylactic acid fibers, polyvinylchloride fibers, polyethylene fibers or polyurethane fibers or combinations thereof.
